(19) United States
(12) Patent Application Publication
(10) Pub. No.: US 2021/0374775 A1
(43) Pub. Date: Dec. 2, 2021

(54) PREDICTIVE SITUATION VISUALIZATION DEVICE, PREDICTIVE SITUATION VISUALIZATION METHOD AND PREDICTIVE SITUATION VISUALIZATION PROGRAM

(71) Applicant: NEC Corporation, Minato-ku, Tokyo (JP)

(72) Inventors: Norihito GOTO, Tokyo (JP); Shuhei YAMADA, Tokyo (JP)

(73) Assignee: NEC Corporation, Minato-ku, Tokyo (JP)

(21) Appl. No.: 17/282,826

(22) PCT Filed: Sep. 11, 2019
(86) PCT No.: PCT/JP2019/035738

§ 371 Date: Apr. 5, 2021

(30) Foreign Application Priority Data
Oct. 11, 2018 (JP) 2018-192737

(51) Int. Cl. G06Q 30/02

(52) U.S. Cl. CPC G06Q 30/0202

(57) ABSTRACT

A prediction result output unit 81 outputs a prediction result in which a predicted value and an actual value are associated with each other, in a predetermined series. An input unit 82 accepts from a user a designation of the prediction result in the output series. A basis output unit 83 outputs a basis for the predicted value in the prediction result for the accepted designation. The basis output unit 83 outputs, as the basis for the predicted value, a product value for each of explanatory variables in a prediction formula used for the prediction, the product value being calculated by multiplying a value of an explanatory variable by a coefficient of the explanatory variable.

### TECHNICAL FIELD

The present invention relates to a predictive situation visualization device, a predictive situation visualization method, and a predictive situation visualization program for visualizing a predictive situation.

### BACKGROUND ART

Future forecasting operations, such as demand forecasting, anomaly detection, and conformity assessment, are performed in a wide range of fields. Data specialists recognize the errors between the predicted values and the actual values and perform maintenance of prediction models as necessary to maintain the accuracy.

There are various ways of representations for prediction models. For example, there are prediction models that express a single objective variable using a plurality of explanatory variables, as in multiple regression analysis. In the prediction formulas used in such prediction models, generally, the coefficient of the explanatory variable represents the magnitude of the impact on the objective variable, so it can be grasped at a glance that the explanatory variable with a large coefficient has a large impact on the prediction.

Non Patent Literature (NPL) 1 describes extracting complicated rules and patterns by using a heterogeneous mixture learning technology and outputting a model of the learned results. The model described in NPL 1 has prediction formulas classified according to the factors such as temperature, day of the week, etc., and each prediction formula is expressed as a linear sum of weighted explanatory variables indicating the respective factors.

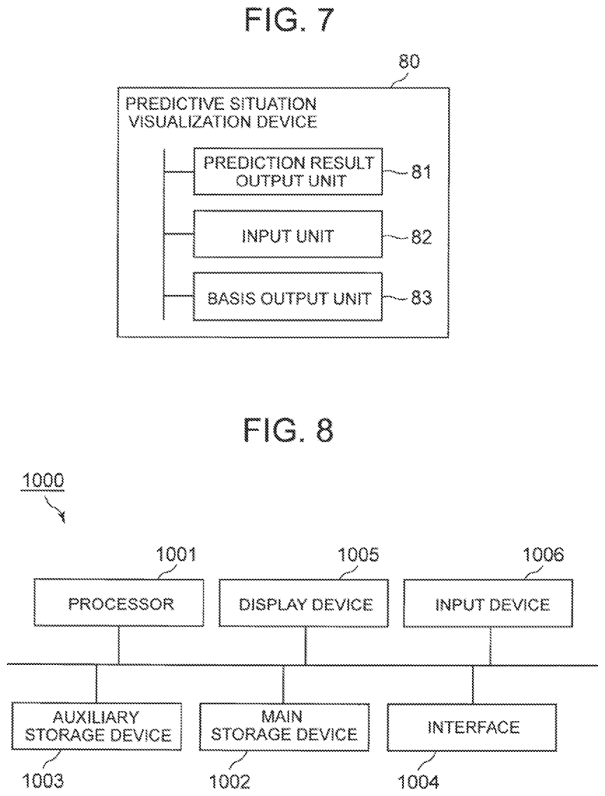

NPL 1 also describes a method of displaying influential factors (explanatory variables) used when making predictions by switching between a plurality of prediction formulas. The display method illustrated in FIG. 7 in NPL 1 is called a stem plot. According to the display method described in NPL 1, the influential factors (explanatory variables) are arranged in the stem portion, and the impacts (coefficients) of the influential factors (explanatory variables) in the respective prediction formulas are expressed cumulatively in the form of bars having the lengths corresponding to the impacts, as in the histogram.

### CITATION LIST

### Non Patent Literature

NPL 1: NEC Corporation, “Data Utilization by Advanced Machine Learning Technology”, Administration & Information Systems, Institute of Administrative Information

### SUMMARY OF INVENTION

### Technical Problem

Data specialists can refer to the influential factors (explanatory variables) described in NPL 1 to determine which explanatory variables affect the predictions to what extent, on the basis of their findings. In the event of a prediction error, however, it is difficult for data specialists to ascertain the causes of the error, even if they can ascertain the existence of some unseen factor.

On the other hand, operational professionals know the situations in the field, so in the event of a situation different from the ordinary operations, they can intuitively grasp a possible error based on their past experience and knowledge. Unlike data specialists, however, operational professionals have difficulty, even by referring to the model used for prediction, in grasping how the model affects the field.

To put it conversely, if the different perspectives, i.e., the findings of data specialists and the knowledge of operational professionals can be integrated together, it will be possible to accelerate the application to analytical operations. For this purpose, it is preferable to be able to visualize the predictive situation such that, in the event of an error between the prediction and the actual result, the operational professionals can interactively grasp the factors that caused the error.

It is therefore an object of the present invention to provide a predictive situation visualization device, a predictive situation visualization method, and a predictive situation visualization program that allow the visualization of the predictive situation such that the factors that caused the error between the prediction and the actual result can be grasped interactively.

### Solution to Problem

A predictive situation visualization device according to the present invention includes: a prediction result output unit that outputs a prediction result in which a predicted value and an actual value are associated with each other, in a predetermined series; an input unit that accepts from a user a designation of the prediction result in the output series; and a basis output unit that outputs a basis for the predicted value in the prediction result for the accepted designation, wherein the basis output unit outputs, as the basis for the predicted value, a product value for each of explanatory variables in a prediction formula used for the prediction, the product value being calculated by multiplying a value of an explanatory variable by a coefficient of the explanatory variable.

A predictive situation visualization method according to the present invention includes: outputting a prediction result in which a predicted value and an actual value are associated with each other, in a predetermined series; accepting from a user a designation of the prediction result in the output series; and outputting a basis for the predicted value in the prediction result for the accepted designation, wherein when outputting the basis, a product value is output, as the basis for the predicted value, for each of explanatory variables in a prediction formula used for the prediction, the product value being calculated by multiplying a value of an explanatory variable by a coefficient of the explanatory variable.

A predictive situation visualization program according to the present invention causes a computer to perform: prediction result output processing of outputting a prediction result in which a predicted value and an actual value are associated with each other, in a predetermined series; input processing of accepting from a user a designation of the prediction result in the output series; and basis output processing of outputting a basis for the predicted value in the prediction result for the accepted designation, wherein, in the basis output processing, a product value is output, as the basis for the predicted value, for each of explanatory variables in a prediction formula used for the prediction, the product value being calculated by multiplying a value of an explanatory variable by a coefficient of the explanatory variable.

### Advantageous Effects of Invention

According to the present invention, the predictive situation can be visualized such that the factors that caused the error between the prediction and the actual result can be grasped interactively.

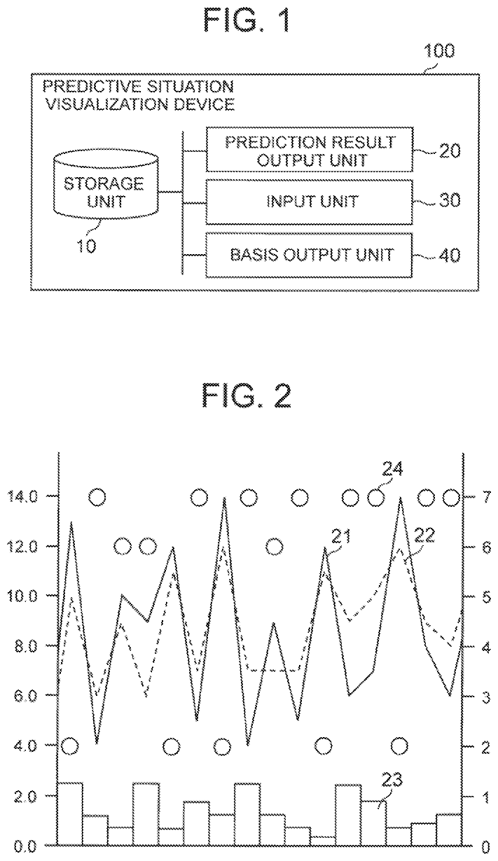

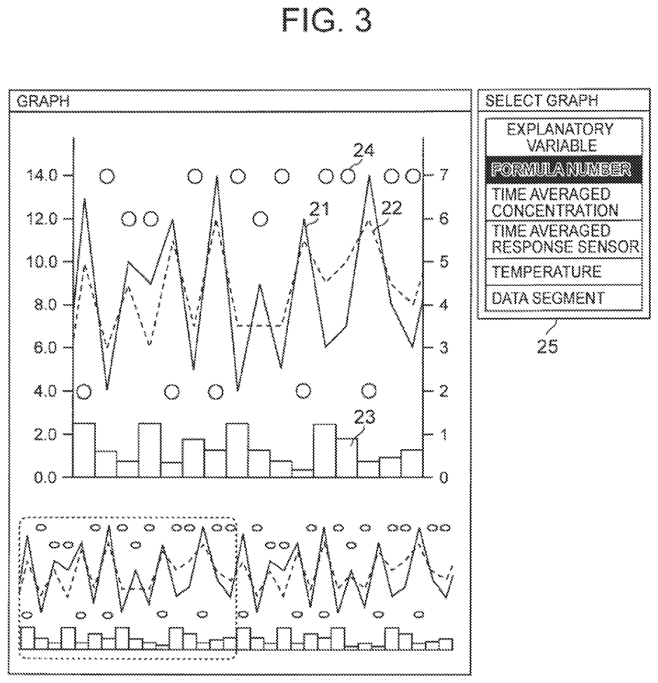

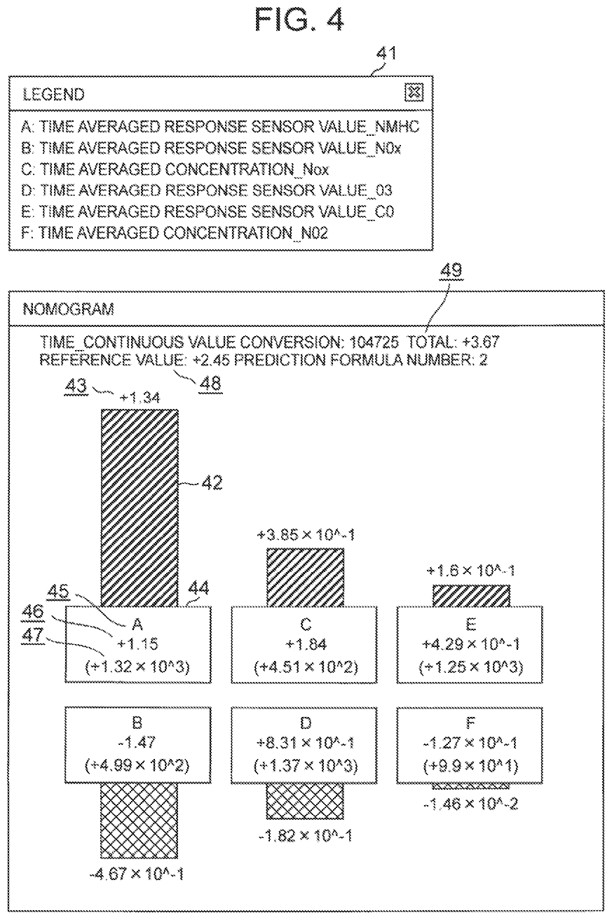

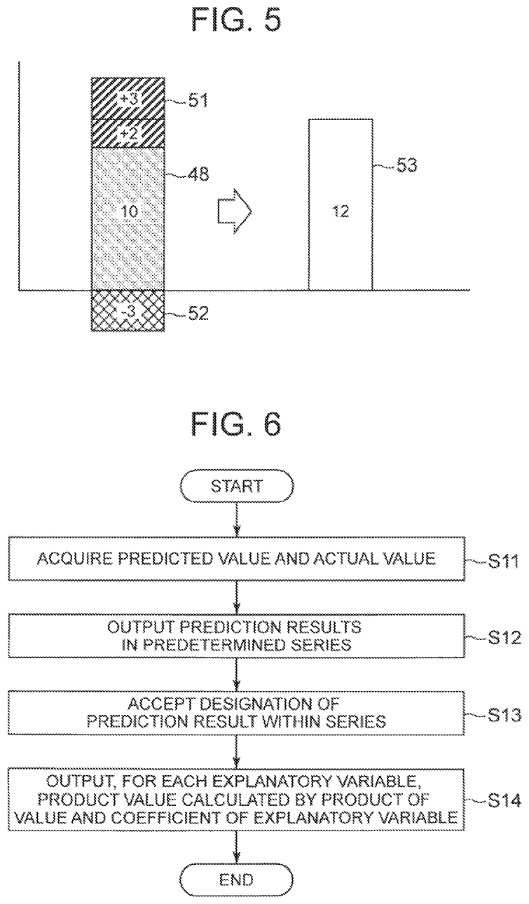

### BRIEF DESCRIPTION OF DRAWINGS

[FIG. 1] It is a block diagram depicting an exemplary configuration of an exemplary embodiment of a predictive situation visualization device according to the present invention.

[FIG. 2] It depicts an exemplary output of prediction results.

[FIG. 3] It depicts another exemplary output of prediction results.

[FIG. 4] It depicts an example of a screen with product values of explanatory variables output thereon.

[FIG. 5] It depicts exemplary processing of calculating a predicted value.

[FIG. 6] It is a flowchart depicting an exemplary operation of a predictive situation visualization device.

[FIG. 7] It is a block diagram depicting an outline of a predictive situation visualization device according to the present invention.

[FIG. 8] It is a schematic block diagram depicting an exemplary configuration of a computer according to an exemplary embodiment of the present invention.

### DESCRIPTION OF EMBODIMENT

An exemplary embodiment of the present invention will be described below with reference to the drawings. In the present invention, the content of a prediction formula (prediction model) used for prediction is not limited as long as the prediction formula is expressed as a linear sum of explanatory variables. For example, a prediction model learned using a heterogeneous mixture learning technology may be used, or an autoregressive integrated moving average (ARIMA) model may be used. The explanatory variables may be expressed as powers.

FIG. 1 is a block diagram depicting an exemplary configuration of an exemplary embodiment of a predictive situation visualization device according to the present invention. The predictive situation visualization device 100 of the present exemplary embodiment includes a storage unit 10, a prediction result output unit 20, an input unit 30, and a basis output unit 40.

The storage unit 10 stores various information necessary for the output. Specifically, the storage unit 10 stores a prediction result in which a predicted value and an actual value are associated with each other. For example, in the case where demand forecasting on a daily basis is performed, the storage unit 10 stores the prediction results by associating the daily predicted values with the observed actual values. The storage unit 10 may also store an error between the predicted and actual values associated with each other.

The storage unit 10 also stores a prediction formula used for the prediction. For example, in the case of a prediction model generated by the heterogeneous mixing learning technology described above, the prediction formula is determined based on predictive data.

Thus, the storage unit 10 may store, along with the prediction model, the predictive data and the prediction formula used for the prediction, in association with the predicted value.

In addition, the storage unit 10 may store a legend showing the contents of explanatory variables, in association with the explanatory variables, for ease of understanding of the contents of the explanatory variables by the operational professionals.

The storage unit 10 may receive and store various data described above from another prediction system (not shown), for example, via a communication network. The storage unit 10 is implemented, for example, by a magnetic disk device.

The prediction result output unit 20 outputs prediction results (specifically, predicted values and actual values) in a predetermined series. Specifically, the prediction result output unit 20 displays the prediction results in a display or other display device (not shown). The way of determining the series is not limited. For example, when the daily demand forecasting as described above is performed, the prediction result output unit 20 outputs the prediction results in a time series.

Further, for example in the case of discriminant analysis that does not involve changes in time (such as presence or absence of constraints, acceptance or rejection on examination), the prediction result output unit 20 may output the prediction results as a series in the order of the degree of confidence in the prediction. Such outputs enable checking the relationship between the degree of confidence and the correctness of a predictor. As another example, the prediction result output unit 20 may output the prediction results as a series in the order of application.

The prediction result output unit 20 may output an error between the predicted value and the actual value, together with the prediction result. In the case of a prediction model generated by heterogeneous mixing learning, the prediction result output unit 20 may output, together with the prediction result, information identifying the prediction formula used for the prediction.

FIG. 2 depicts an exemplary output of prediction results. The example illustrated in FIG. 2 indicates that the prediction result output unit 20 outputs a predicted value 21 and an actual value 22 in the form of a line graph in a time series. In the example illustrated in FIG. 2, the prediction result output unit 20 outputs an error 23 between the predicted value 21 and the actual value 22 in the form of a bar chart, in association with the prediction result, and plots a prediction formula 24 used for each prediction, at a position corresponding to the number of the prediction formula. The vertical axis scale on the right of the graph illustrated in FIG. 2 indicates the prediction formula number, and the vertical axis scale on the left indicates the value of the objective variable.

The prediction result output unit 20 may output the value of the explanatory variable used for the prediction, instead of the prediction formula number. That is, the prediction result output unit 20 may output the prediction formula used for the prediction or the value of the explanatory variable in a selectable manner. Further, the prediction result output unit 20 may output a selected range of the prediction results in enlarged view.

FIG. 3 depicts another exemplary output of prediction results. In the example illustrated in FIG. 3, an explanatory variable list 25 used in the prediction is displayed on the right side of the screen, and when a user selects the explanatory variable desired to be displayed, the prediction result output unit 20 outputs the value of the explanatory variable used in the prediction. In this case, the right vertical axis scale may be changed to represent the value of the explanatory variable.

In the example shown in FIG. 3, the entirety of the prediction results is displayed at the bottom of the screen. When a user selects a range (e.g., a range delimited by the dotted line) the user wishes to be displayed, the prediction result output unit 20 magnifies and outputs the prediction results in the selected range. The prediction result output unit 20 may select a section to output the prediction results from among a learning section, an evaluation section, and a prediction section. These sections are selected, for example, by the user.

It should be noted that the output format is not limited to the format illustrated in FIG. 2. For example, the prediction result output unit 20 may output the prediction results in a scatter plot, instead of the line graph. In addition, the prediction result output unit 20 may switch between the display and non-display of the elements in the output graph according to instructions from the user.

The input unit 30 accepts from a user a designation of the prediction result from within the output series. Specifically, the input unit 30 accepts from the user a designation of the prediction result that the user wishes to grasp in detail as a basis for the predicted value.

The designation may be accepted in any manner. For example, the input unit 30 may detect that the prediction result has been selected from the series on the screen in response to a user manipulating a cursor on the screen using a pointing device.

For example, in the case where demand forecasting is performed on a daily basis, the prediction result output unit 20 displays the daily predicted values and actual values in a time series. In this case, the input unit 30 may accept a designation of the prediction target date from the displayed time series.

The basis output unit 40 outputs a basis for the predicted value in the prediction result for the accepted designation. Specifically, when the input unit 30 detects that the cursor has been placed over a prediction result, the basis output unit 40 may output the basis for the predicted value in the prediction result. When the input unit 30 detects that a pointing device has been clicked on a prediction result, the basis output unit 40 may output the basis for the predicted value in the prediction result. At this time, the basis output unit 40 may output a basis according to the detected content.

In the present exemplary embodiment, when it is detected that the cursor has been placed over a prediction result, the prediction result output unit 20 outputs the predicted value, the actual value, the error, and the number of the currently selected formula or the value of the explanatory variable, on the same screen in a manner distinguishable from the other display contents. Further, when it is detected that the pointing device has been clicked on a prediction result, the basis output unit 40 displays another screen and outputs product values of explanatory variables. As used herein, the product value of an explanatory variable refers to a value calculated multiplied by a coefficient of the explanatory variable.

FIG. 4 depicts an example of a screen with product values of explanatory variables output thereon. As illustrated in FIG. 4, the basis output unit 40 outputs, as the basis for the predicted value, a product value for each of explanatory variables in a prediction formula used for the prediction, wherein the product value is calculated by multiplying a value of an explanatory variable by a coefficient of the explanatory variable. In the following description, the basis displayed in the form illustrated in FIG. 4 may be referred to as a nomogram representation. As illustrated in FIG. 4, the basis output unit 40 may also display a legend 41 together to facilitate understanding of the contents of the explanatory variables.

The nomogram representation illustrated in FIG. 4 will be described in detail below. In the present exemplary embodiment, the basis output unit 40 outputs a graph that represents the product value for each explanatory variable. Specifically, the basis output unit 40 outputs the product value for each explanatory variable in the form of a vertical bar 42 according to the magnitude of the product value. The vertical bars are by way of example; the bars may be displayed laterally, for example. In order for a product value of an explanatory variable to be used as a basis for the predicted value, the basis output unit 40 calculates and outputs, for each standardized explanatory variable in predictive data, the product of a value and a coefficient of the explanatory variable.

As illustrated in FIG. 4, the basis output unit 40 may output, on top of or beneath each bar, a value 43 indicating the product value of the corresponding explanatory variable. That is, the value 43 represents the length of the bar as a numeric value.

Further, a rectangular display area 44 is provided associated with each bar 42. The basis output unit 40 outputs to each display area 44 an explanatory variable 45, an actual value 46 of the explanatory variable, and a value 47 of a reverse standardized real number. Specifically, the value 46 is the value of the standardized explanatory variable in the predictive data. Further, as a prediction formula generally represents a relational formula between an objective variable and standardized explanatory variables, the value 47 of the reverse standardized real number represents the value of the explanatory variable in the predictive data. In addition, a reference value 48 illustrated in FIG. 4 is a so-called intercept (bias) of the prediction formula, and a total 49 is a value of the objective variable for the designated prediction target.

For example, when a prediction formula is expressed as y=a₁x₁+a₂x₂+b, the product value for the explanatory variable xi is calculated as a₁x₁. In this case, b corresponds to the reference value 48. Accordingly, the objective variable y (i.e., the predicted value) is derived by the sum of the product values (i.e., the lengths of the bars 42) of the respective explanatory variables and the reference value 48. FIG. 5 depicts exemplary processing of calculating a predicted value. As illustrated in FIG. 5, a predicted value 53 is calculated by adding a product value 51 of an explanatory variable having a positive influence and a product value 52 of an explanatory variable having a negative influence, to the reference value 48. The example illustrated in FIG. 5 shows that, with the reference value being 10, the product values (+3) and (+2) of two explanatory variables with a positive influence and the product value (−3) of one explanatory variable with a negative influence yield a predicted value of 12.

Further, the basis output unit 40 may output a graph that represents the product values of the explanatory variables side by side for each sign of the product value. FIG. 4 illustrates a case in which the basis output unit 40 outputs rows of bars representing the product values of the respective explanatory variables for each sign of the product value. Specifically, the basis output unit 40 outputs the bars 42 of the explanatory variables for which the product values are positive in the upper row, in descending order of the absolute value, and outputs the bars 42 of the explanatory variables for which the product values are negative in the lower row, in descending order of the absolute value. Alternatively, the basis output unit 40 may output the bars 42 of the explanatory variables collectively in descending order of the absolute value, regardless of the sign of the product value of the explanatory variable. That the basis output unit 40 outputs the explanatory variables side by side for each sign of the product value, as illustrated in FIG. 4, provides easier grasping of the product values that affects the objective variable.

The prediction result output unit 20, the input unit 30, and the basis output unit 40 are implemented by a processor (e.g., a central processing unit (CPU), a graphics processing unit (GPU), a field-programmable gate array (FPGA)) of a computer that operates in accordance with a program (the predictive situation visualization program).

For example, with the program being stored in the storage unit 10, the processor may read the program and operate as the prediction result output unit 20, the input unit 30, and the basis output unit 40 in accordance with the program. The functions of the predictive situation visualization device 100 may also be provided in the form of Software as a Service (SaaS).

The prediction result output unit 20, the input unit 30, and the basis output unit 40 may each be implemented by dedicated hardware. Further, some or all of the components of each device may be implemented by general purpose or dedicated circuitry, processors, etc., or combinations thereof They may be configured by a single chip or a plurality of chips connected via a bus. Some or all of the components of each device may be implemented by a combination of the above-described circuitry etc. and the program.

In addition, when some or all of the components of the predictive situation visualization device 100 are realized by a plurality of information processing devices or circuits, the information processing devices or circuits may be distributed in a centralized or distributed manner. For example, the information processing devices or circuits may be implemented in the form of a client server system, a cloud computing system, or the like, in which the devices or circuits are connected via a communication network.

An operation of the predictive situation visualization device according to the present exemplary embodiment will now be described. FIG. 6 is a flowchart depicting an exemplary operation of a predictive situation visualization device according to the present exemplary embodiment.

The prediction result output unit 20 acquires a predicted value and an actual value from the storage unit 10 (step S11), and outputs a prediction result in which the predicted value and the actual value are associated with each other, in a predetermined series (step S12). The input unit 30 accepts from a user a designation of the prediction result within the output series (step S13). The basis output unit 40 outputs, for each of explanatory variables in the prediction formula used for the prediction, a product value calculated by multiplying a value of the explanatory variable by a coefficient of the explanatory variable, as a basis for the predicted value (step S14).

As described above, in the present exemplary embodiment, the prediction result output unit 20 outputs a prediction result in which a predicted value and an actual value are associated with each other, in a predetermined series, and the input unit 30 accepts from a user a designation of the prediction result from within the output series. Then, the basis output unit 40 outputs a basis for the predicted value in the prediction result for the accepted designation. Specifically, the basis output unit 40 outputs, as the basis for the predicted value, a product value for each of explanatory variables in the prediction formula used for the prediction, wherein the product value is calculated by multiplying a value of the explanatory variable by a coefficient of the explanatory variable. This allows the visualization of the predictive situation such that the factors that caused the error between the prediction and the actual result can be grasped interactively.

That is, the prediction result output unit 20 outputs an error between the prediction and the actual result macroscopically, the input unit 30 accepts from time to time the designation of the prediction result that is noticed by the user, and the basis output unit 40 outputs a basis for the predicted value. In the present exemplary embodiment, the analysis can be performed interactively by the user, also enabling accelerated application to the analytical operations.

For example, with the stem plot described in NPL 1, although it is possible to grasp the impacts of the explanatory variables in each prediction formula, it is difficult to immediately determine to what extent each explanatory variable affects the prediction result. On the other hand, in the present exemplary embodiment, the basis output unit 40 outputs, for each of explanatory variables in the prediction formula used for the prediction, a product value calculated by multiplying a value of the explanatory variable by a coefficient of the explanatory variable, as the basis for the predicted value. This permits grasping, at a glance, the degrees to which the explanatory variables contribute to the prediction result.

That is, in the present exemplary embodiment, the basis output unit 40 outputs the product value of each explanatory variable as the basis for the predicted value. This allows the operational professionals to grasp the product values of the explanatory variables affecting the prediction results, thereby contributing to identification of the factors causing the errors that have occurred in the field. If the factors can be identified, the data specialists can add or modify the factors that cannot be represented by the explanatory variables currently used for prediction, the manner of representation of the explanatory variables (such as adjustment of the way of grouping, the representation format, etc.), and so on.

An outline of the present invention will now be described. FIG. 7 is a block diagram depicting an outline of a predictive situation visualization device according to the present invention. The predictive situation visualization device 80 according to the present invention (e.g., the predictive situation visualization device 100) includes a prediction result output unit 81 (e.g., the prediction result output unit 20) that outputs a prediction result in which a predicted value and an actual value are associated with each other, in a predetermined series (e.g., a time series), an input unit 82 (e.g., the input unit 30) that accepts from a user a designation of the prediction result in the output series, and a basis output unit 83 (e.g., the basis output unit 40) that outputs a basis for the predicted value in the prediction result for the accepted designation.

The basis output unit 83 outputs, for each of explanatory variables in a prediction formula used for the prediction, a product value calculated by multiplying a value of the explanatory variable by a coefficient of the explanatory variable, as the basis for the predicted value (for example, a nomogram representation).

Such a configuration allows the visualization of the predictive situation such that the factors that caused the error between the prediction and the actual result can be grasped interactively.

The basis output unit 83 may output a graph that represents the product value for each explanatory variable (for example, the bar according to the magnitude of the product value). That the basis output unit 83 thus outputs a graph enabling a comparison of the magnitude of one product value with that of another product value facilitates a comparison by a user between the product values of one explanatory variable and another explanatory variable.

In addition, the basis output unit 83 may output a graph that represents the product values of the explanatory variables side by side for each sign of the product value. Such a configuration facilitates grasping the trend of the product values of the explanatory variables.

The basis output unit 83 may output a value of a standardized explanatory variable in association with a product value of the explanatory variable. This configuration enables grasping the value as which the value of the predictive data is used in the prediction.

In addition, the prediction result output unit 81 may output a prediction formula used for the prediction and a value of an explanatory variable in a selectable manner.

FIG. 8 is a schematic block diagram depicting an exemplary configuration of a computer according to an exemplary embodiment of the present invention. The computer 1000 includes a processor 1001, a main storage device 1002, an auxiliary storage device 1003, an interface 1004, a display device 1005, and an input device 1006.

The information processing system of the present invention is implemented in the computer 1000. The operations of the information processing system of the present invention are stored in the auxiliary storage device 1003 in the form of a program (the predictive situation visualization program). The processor 1001 reads the program from the auxiliary storage device 1003 and deploys the program to the main storage device 1002 to perform the above-described processing in accordance with the program.

In at least one exemplary embodiment, the auxiliary storage device 1003 is an example of a non-transitory tangible medium. Other examples of the non-transitory tangible media include a magnetic disk, magneto-optical disk, CD-ROM (Compact Disc Read-only memory), DVD-ROM (Read-only memory), semiconductor memory, and the like, connected via the interface 1004. In the case where the program is delivered to the computer 1000 via a communication line, the computer 1000 receiving the delivery may deploy the program to the main storage device 1002 and perform the above-described processing.

The program may also be for implementing a part of the processing described above. Further, the program may be a differential program that achieves the above-described processing in combination with another program already stored in the auxiliary storage device 1003. An input from the user is accepted via the input device 1006, and the display device 1005 displays the accepted results.

While the present invention has been described with reference to exemplary embodiments and examples, the present invention is not limited to the exemplary embodiments or examples above. The configurations and details of the present invention can be subjected to various modifications appreciable by those skilled in the art within the scope of the present invention.

This application claims priority based on Japanese Patent Application No. 2018-192737 filed Oct. 11, 2018, the disclosure of which is incorporated herein in its entirety.

### REFERENCE SIGNS LIST

10 storage unit

20 prediction result output unit

21 predicted value

22 actual value

23 error

24 prediction formula

25 explanatory variable list

30 input unit

40 basis output unit

41 legend

42 bar

53 predicted value

100 predictive situation visualization device

What is claimed is:

1. A predictive situation visualization device, comprising a hardware processor configured to execute a software code to:
output a prediction result in which a predicted value and an actual value are associated with each other, in a predetermined series;
accept from a user a designation of the prediction result in the output series; and
output a basis for the predicted value in the prediction result for the accepted designation,
wherein the hardware processor is configured to execute a software code to output, as the basis for the predicted value, a product value for each of explanatory variables in a prediction formula used for the prediction, the product value being calculated by multiplying a value of an explanatory variable by a coefficient of the explanatory variable.

2. The predictive situation visualization device according to claim 1, wherein the hardware processor is configured to execute a software code to output a graph that represents the product value for each explanatory variable.

3. The predictive situation visualization device according to claim 2, wherein the hardware processor is configured to execute a software code to output a graph that represents the product values of the explanatory variables side by side for each sign of the product value.

4. The predictive situation visualization device according to claim 1, wherein the hardware processor is configured to execute a software code to output a value of a standardized explanatory variable in association with a product value of the explanatory variable.

5. The predictive situation visualization device according to claim 1, wherein the hardware processor is configured to execute a software code to selectably output a prediction formula used for the prediction and a value of an explanatory variable.

6. A predictive situation visualization method, comprising:
outputting a prediction result in which a predicted value and an actual value are associated with each other, in a predetermined series;
accepting from a user a designation of the prediction result in the output series; and
outputting a basis for the predicted value in the prediction result for the accepted designation,
wherein when outputting the basis, a product value is output, as the basis for the predicted value, for each of explanatory variables in a prediction formula used for the prediction, the product value being calculated by multiplying a value of an explanatory variable by a coefficient of the explanatory variable.

7. The predictive situation visualization method according to claim 6, wherein a graph that represents the product value for each explanatory variable is output.

8. A non-transitory computer readable information recording medium storing a predictive situation visualization program, when executed by a processor, that performs a method for:
outputting a prediction result in which a predicted value and an actual value are associated with each other, in a predetermined series;
accepting from a user a designation of the prediction result in the output series; and
outputting a basis for the predicted value in the prediction result for the accepted designation,
wherein when outputting the basis, a product value is output, as the basis for the predicted value, for each of explanatory variables in a prediction formula used for the prediction, the product value being calculated by multiplying a value of an explanatory variable by a coefficient of the explanatory variable.

9. The non-transitory computer readable information recording medium according to claim 8, wherein a graph that represents the product value for each explanatory variable is output.
